(19) United States
(12) Patent Application Publication
(10) Pub. No.: US 2015/0362955 A1
(43) Pub. Date: Dec. 17, 2015

(54) OPENING-CLOSING-TYPE ELECTRONIC DEVICE

(71) Applicant: Kabushiki Kaisha Toshiba, Tokyo (JP)

(72) Inventors: Yuki Hayashi, Tachikawa Tokyo (JP); Masaaki Taji, Ome Tokyo (JP)

(21) Appl. No.: 14/590,373

(22) Filed: Jan. 6, 2015

Related U.S. Application Data
(60) Provisional application No. 62/013,277, filed on Jun. 17, 2014.

(51) Int. Cl. G06F 1/16; G11B 33/10; G11B 33/02

(52) U.S. Cl. CPC G06F 1/1677; G11B 33/022; G11B 33/10

(57) ABSTRACT

According to one embodiment, an opening-closing-type electronic device includes a magnetic recording medium including a drive member with a magnet, and a drive assembly which includes the drive member and is driven by the drive member, a magnetic sensor which detects a magnetic field of the magnetic recording medium and outputs a signal when a magnetic flux density of the magnetic field reaches a threshold, and an opening and closing mechanism which is formed such that it can be opened and closed, and in which a part of the magnetic recording medium and the magnetic sensor are arranged in line facing each other when the mechanism is closed.

### CROSS-REFERENCE TO RELATED APPLICATIONS

This application claims the benefit of U.S. Provisional Application No. 62/013,277, filed Jun. 17, 2014, the entire contents of which are incorporated herein by reference.

### FIELD

Embodiments described herein relate generally to an electronic device having an opening and closing function.

### BACKGROUND

A foldable clamshell-type notebook computer has the function of detecting whether the computer is folded or not for turning off a display or bringing the display into a sleep (hibernation) state when the computer is folded. Such a function is realized by a magnetic sensor and a magnet in the clamshell-type notebook computer. In such a clamshell-type notebook computer, generally, the magnetic sensor is arranged at a position where a magnetic field of the magnet can be detected when it is closed. Recently, in addition to the moderate price of a notebook computer, slimness and lightness as compared to old models are emphasized. Accordingly, in the computer, components are arranged in close proximity to each other. In such arrangement, the magnetic sensor may detect a magnetic force produced by other components in the notebook computer.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic view of an opening-closing-type electronic device;

FIG. 2 is a block diagram of the opening-closing-type electronic device of a first embodiment;

FIG. 3 is a schematic view showing an example of a structure of an HDD;

FIG. 4 is a diagram showing electromagnetic conversion characteristics of a magnetic sensor;

FIG. 5A is a plan view showing a state in which the opening-closing-type electronic device is opened;

FIG. 5B is a cross-sectional view taken along line A-A of FIG. 5A;

FIG. 6A is a plan view showing a state in which the opening-closing-type electronic device is closed;

FIG. 6B is a cross-sectional view taken along line B-B of FIG. 6A;

FIG. 7A is plan view showing a state in which an opening-closing-type electronic device of a modification is opened;

FIG. 7B is a cross-sectional view taken along line C-C of FIG. 7A;

FIG. 8A is a plan view showing a state in which the opening-closing-type electronic device of the modification is closed;

FIG. 8B is a cross-sectional view taken along line D-D of FIG. 8A;

FIG. 9 is a schematic view of an opening-closing-type electronic device of a second embodiment;

FIG. 10 is a block diagram showing the opening-closing-type electronic device of the second embodiment;

FIG. 11A is a perspective view showing a state in which the opening-closing-type electronic device is opened; and

FIG. 11B is a perspective view showing a state in which the opening-closing-type electronic device is closed.

### DETAILED DESCRIPTION

Various embodiments will be described hereinafter with reference to the accompanying drawings.

In general, according to one embodiment, an opening-closing-type electronic device comprises: a magnetic recording medium comprising a drive member including a magnet, and a drive assembly which comprises the drive member and is driven by the drive member; a magnetic sensor configured to detect a magnetic field of the magnetic recording medium and to output a signal when a magnetic flux density of the magnetic field reaches a threshold; and an opening and closing mechanism configured to be opened and closed, and in which a part of the magnetic recording medium and the magnetic sensor are arranged in line facing each other when the mechanism is closed.

Embodiments will be described hereinafter with reference to the accompanying drawings.

### First Embodiment

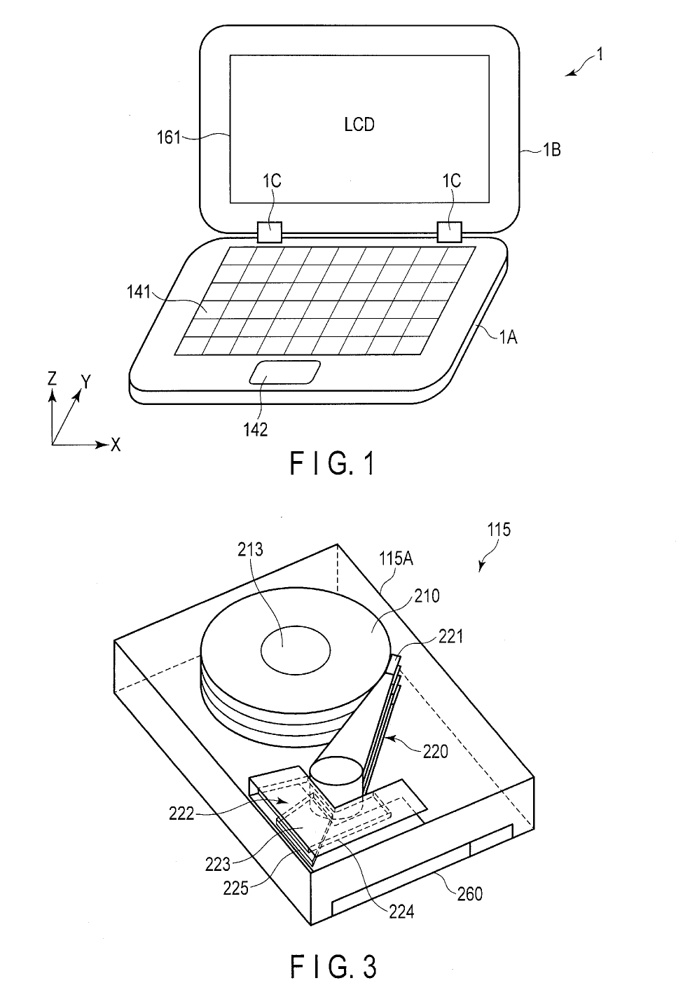

FIG. 1 is a schematic view of a foldable (clamshell-type) personal computer 1. The clamshell-type personal computer (opening-closing-type electronic device) 1 comprises a first housing 1A, a second housing 1B, and hinges (connection portions) 1C which connect the first housing 1A and the second housing 1B in a foldable manner.

The first housing 1A comprises operation keys (an input operation portion) 141. The second housing 1B comprises a display 161. The first housing 1A and the second housing 1B are formed in substantially the same size. Accordingly, the first housing 1A and the second housing 1B rotate about a rotation axis of each of the hinges 1C when the personal computer 1 is folded, and the first housing 1A and the second housing 1B match with each other like sea shells.

It should be noted that the opening-closing-type electronic device 1 is not limited to a clamshell-type notebook computer, and may be a tablet computer, a smartphone, a mobile phone, an electronic dictionary, etc., as long as it is an electronic device having an opening and closing function.

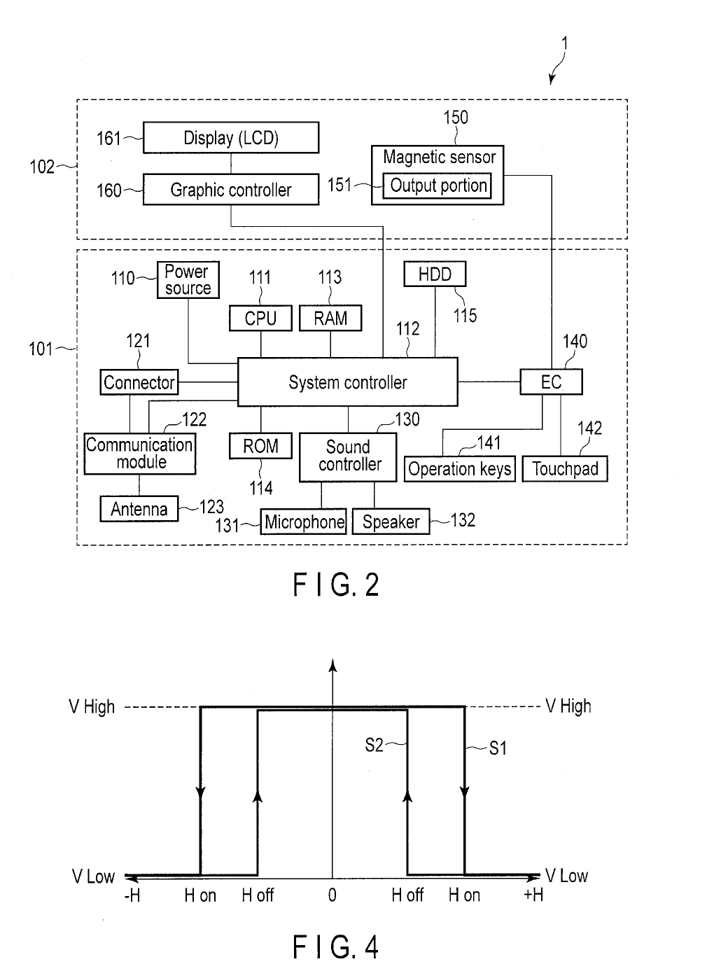

An example of a structure of the opening-closing-type electronic device 1 will be described with reference to FIG. 2. FIG. 2 is a block diagram of the opening-closing-type electronic device 1 according to the present embodiment.

The opening-closing-type electronic device 1 comprises a body device (body unit) 101 and a display device (display unit) 102. The body device 101 is included in the first housing 1A, and the display device 102 is included in the second housing 1B.

The body device (body unit) 101 comprises a power source 110, a CPU (controller) 111, a system controller 112, a RAM 113, a ROM 114, a magnetic recording medium (HDD) 115, a connector 121, a communication module 122, and an antenna 123 inside the first housing 1A. Further, the opening-closing-type electronic device 1 comprises a sound controller 130, a microphone 131, a speaker 132, an embedded controller (EC) 140, the operation keys 141, and a touchpad 142.

The power source 110 is a source of power for the opening-closing-type electronic device 1. The power source 110 includes an AC adapter, a battery, etc. The power source 110 controls power supplied from an external power source by the system controller 112 which will be described later during charging.

The CPU (controller) 111 is a processor which controls the operation of various modules mounted in the opening-closing-type,electronic device 1. The ROM 114 stores data generated by a program executed by the CPU 111, or an operation instruction or data, etc., which is input to the opening-closing-type electronic device 1 by way of the operation keys 141 in a volatile manner. The ROM 114 stores data in a nonvolatile manner. Further, the ROM 114 is a ROM in which data can be written and from which the data can be erased, such as an erasable programmable read-only memory (EPROM) and a flash memory.

The CPU 111 executes various kinds of software loaded into the RAM 113 from the magnetic recording medium 115, which is a nonvolatile storage device. The CPU 111 performs the control to turn off the display 161 or bring the display 161 into a sleep (hibernation) state when the CPU 111 receives a signal from the EC 140 which will be described later. The CPU 111 also executes a basic input output system (BIOS) stored in the ROM 114. The BIOS is a program for hardware control.

The system controller 112 is a device which connects between the CPU 111 and the various components. A memory controller for controlling access to the RAM 113 is built into the system controller 112. Also, the system controller 112 controls the amount of power supply to the power source 110 from the external power source. The power source 110, the CPU 111, the RAM 113, the ROM 114, the magnetic recording medium 115, the connector 121, the communication module 122, the sound controller 130, the EC 140, a magnetic sensor 150, a graphic controller 160, etc., are connected to the system controller 112.

A structure of the magnetic recording medium 115 will be described with reference to FIG. 3. FIG. 3 is a schematic view showing an example of the structure of the magnetic recording medium 115.

The magnetic recording medium 115 is an HDD, for example. The magnetic recording medium 115 will be hereinafter referred to as the HDD 115. The HDD 115 comprises an HDD housing 115A. The HDD 115 includes a disk 210, a spindle motor (SPM) 213, an actuator (drive assembly) 220, a head 221, a voice coil motor (VCM) (drive member) 222, and a host interface (storage interface) 260 in the HDD housing 115A.

The HDD housing 115A is formed in the shape of a rectangular parallelepiped having long and short axes.

The disk 210 comprises a recording surface on which data is magnetically recorded on one side of the disk, for example. The disk 210 is rotated at high speed by the SPM 213. The disk 210 is arranged near either end of the longitudinal axis of the HDD housing 115A.

The SPM 213 is actuated by a drive current (or a drive voltage) supplied from the power source 110 via the host interface 260.

The actuator 220 comprises the voice coil motor (VCM) 222 which serves as a driving source of the actuator 220. The actuator 220 is arranged near an end opposite to the disk 210 in a longitudinal direction of the HDD housing 115A.

The head (head slider) 221 is arranged to correspond to the recording surface of the disk 210. The head 221 is mounted on a distal end of a suspension extending from an arm of the actuator 220.

The voice coil motor (VCM) (drive member) 222 includes a magnet 223, a yoke 224, and a coil 225. The VCM (drive member) 222 is connected to a pivot portion of the actuator 220, and provided at a corner of the HDD housing 115A. The VCM 222 is driven by the drive current supplied from the power source 110 via the host interface 260. The head 221 is moved in a radial direction of the disk 210 over the disk 210 to draw an arc as the actuator 220 is driven by the VCM 222.

The magnet 223 produces a magnetic field to move the actuator 220. For example, the magnet 223 is constituted of a rare-earth metal which produces a large magnetic flux density by a small volume.

The yoke 224 is made of metal. The yoke 224 is made of soft iron, for example. The yoke 224 is brought into contact with the magnet 223 to make the magnetic force of the magnet 223 more efficient. That is, the yoke 224 is provided to change a flow of magnetic lines of force of the magnet 223. For example, the yoke 224 is provided so as not to produce a magnetic flux in an unnecessary part.

The coil 225 is formed in a wound trapezoidal shape, for example. A current passes through the coil 225. When the current is passed to the coil 225 in a magnetic field produced by the magnet 223, a driving force is generated. The coil 225 generates a propulsive force by a magnetic force generated in the trapezoidal portion. The VCM 222 moves by the propulsive force generated by the coil 225.

The host interface 260 includes a power source unit and a signal unit. In the host interface 260, a power cable is connected to the power source unit, and a signal cable is connected to the signal unit. The HDD 115 transmits data to other components of the opening-closing-type electronic device 1 and receives data from the same via the host interface 260.

Referring to FIG. 2 again, the connector 121 is a connection terminal for connecting with another apparatus. For example, the connector 121 includes a USB connector, a LAN connector, etc.

The communication module 122 controls communication with another electronic apparatus. For example, the communication module 122 communicates with another electronic apparatus via the connector 121. Also, the communication module 122 wirelessly communicates with another electronic apparatus via the antenna. The communication module 122 can also execute wire communication with another electronic apparatus via the connector 121.

The sound controller 130 is a controller for processing a speech signal, and controls a speech input from the microphone 131 and a speech output from the speaker 132.

The embedded controller (EC) 140 is a one-chip microcomputer including a controller for power management. The EC (control unit) 140 has the function of powering the opening-closing-type electronic device 1 on or off in accordance with an operation by a user, and the function of transmitting a signal for turning off the display 161 or bringing the display 161 into a sleep (hibernation) state to the CPU 111. For example, the EC 140 turns on power or turns off power by detecting that the user has pressed a power button. Also, the EC 140 controls the opening-closing-type electronic device 1 by detecting signals from the operation keys 141, the touchpad 142, and the magnetic sensor which will be described later.

Next, the display device (display unit) 102 will be described. In the present embodiment, the display device 102 includes the magnetic sensor 150, the graphic controller 160, and the display 161 in the second housing 1B.

The magnetic sensor 150 will be described with reference to FIG. 4. FIG. 4 is a diagram showing electromagnetic conversion characteristics of the magnetic sensor 150. In FIG. 4, the horizontal axis represents a magnetic flux density, and the vertical axis represents a voltage. In the horizontal axis of FIG. 4, “H on” indicates a detection level of the magnetic flux density of the magnetic sensor 150, and “H off” indicates an open level of the magnetic flux density.

The magnetic sensor 150 detects an opened or closed state of the opening-closing-type electronic device 1. States in which the body device 101 and the display device 102 are physically opened and closed differ from the opened state and the closed state detected by the magnetic sensor 150 depending on thresholds of the magnetic force set to the magnetic sensor 150. The magnetic sensor 150 measures magnitude of a magnetic field (magnetic flux density) and a direction of the same, and outputs a signal. The magnetic sensor 150 comprises an output portion 151 configured to output a signal with respect to the detected magnetic flux density.

More specifically, the thresholds of the magnetic force are set to the output portion 151. The thresholds of the magnetic force are set to the output portion 151 as reference voltages. The output portion 151 outputs a voltage of detection level “Low” as a signal to the EC 140 when the magnetic flux density is a non-detection threshold or below. Meanwhile, the output portion 151 outputs a voltage of detection level “high” as a signal to the EC 140 when the magnetic flux density is a detection threshold or more. Accordingly, the magnetic sensor 150 can detect the opened or closed state of the opening-closing-type electronic device 1. That is, the magnetic sensor 150 outputs a signal of detection level “high” when the opening-closing-type electronic device 1 is opened, and outputs detection level “Low” when it is closed.

In the present embodiment, the magnetic sensor 150 detects the magnetic field of the magnet 223 of the actuator 220 (more specifically, the VCM 222) of the HDD 115. The magnetic sensor 150 outputs a signal to the EC 140 when a magnetic flux density not less than the threshold is detected. In FIG. 4, S1 indicates an output of the output portion 151 when the magnetic sensor 150 has come close to the magnetic field produced by the actuator 220. That is, S1 indicates a change of the form of the opening-closing-type electronic device 1 from the opened state to the closed state. Further, S2 indicates an output of the output portion 151 when the magnetic sensor 150 is moved away from the magnetic field produced by the actuator 220. That is, S2 indicates a change of the form of the opening-closing-type electronic device 1 from the closed state to the opened state.

Referring to FIG. 2 again, the graphic controller 160 controls the display 161 to be described later of the opening-closing-type electronic device 1. The graphic controller 160 transmits a display signal to the display 161 in accordance with control of the CPU 111.

The display 161 is, for example, an LCD (liquid crystal display). The display 161 will be hereinafter referred to as the LCD 161. The LCD 161 displays a screen image in accordance with the display signal. Note that for the LCD 161, a touchpanel may be disposed on a display surface. Here, the touchpanel is, for example, a capacitive sensor for performing an input on a screen of the LCD 161.

(Structure of Opening-Closing-Type Electronic Device)

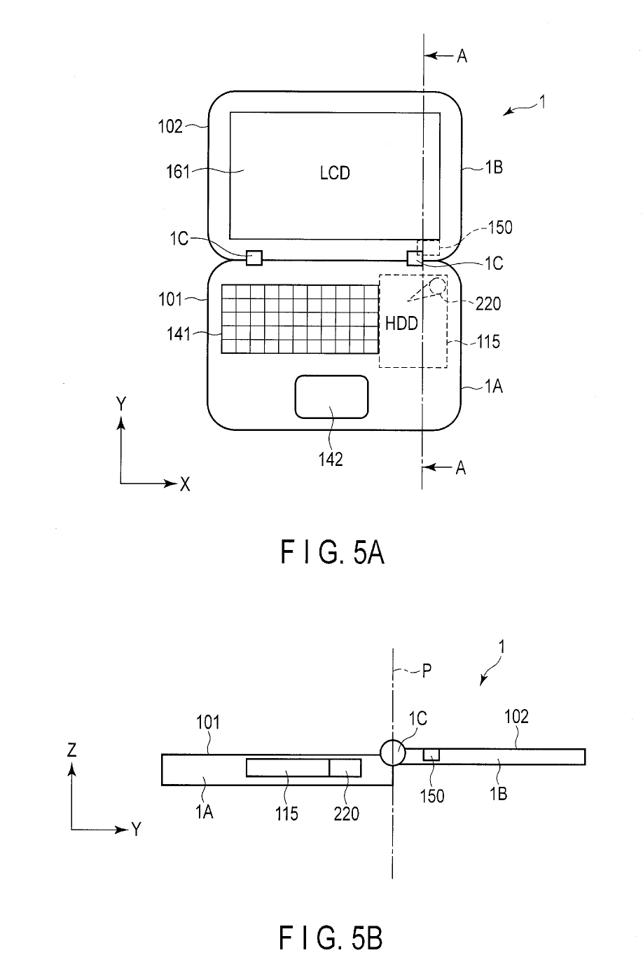

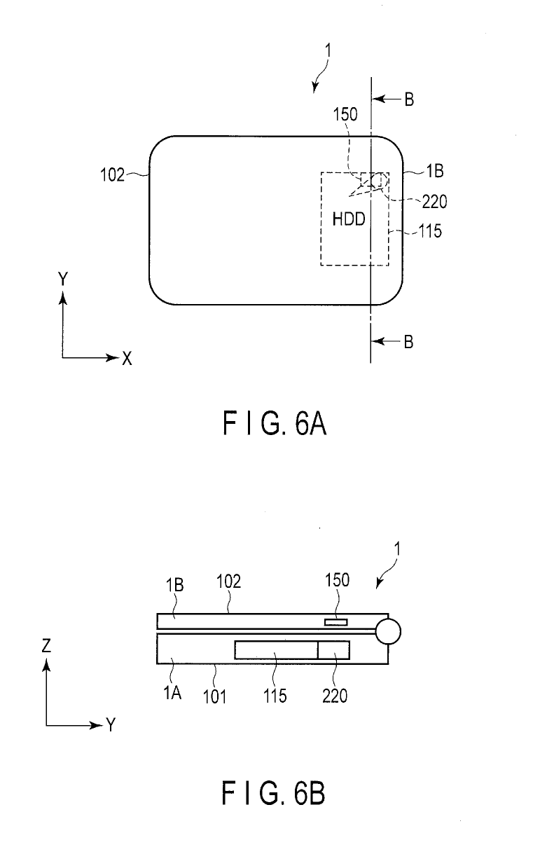

Next, a structure of the opening-closing-type electronic device 1, and arrangement of the HDD 1 and the magnetic sensor 150, in particular, will be described with reference to FIGS. 5A, 5B, 6A, and 6B. In the present embodiment, the magnetic sensor 150 detects the magnetic field of the actuator 220, and the opened or closed state of the opening-closing-type electronic device 1 is controlled by the EC 140. In a state where the opening-closing-type electronic device 1 is closed, the HDD 115 and the magnetic sensor 150 are disposed to face each other. That is, the HDD 115 and the magnetic sensor 150 are arranged so that they face each other in line when the opening-closing-type electronic device 1 is closed. For example, the magnetic sensor 150 is provided at a portion which faces the VCM 222 of the actuator 220.

FIG. 5A is a plan view showing the opened state of the opening-closing-type electronic device 1. FIG. 5B is a cross-sectional view taken along line A-A of FIG. 5A. The X- and Y-axes, which are orthogonal to each other, are defined as shown in FIG. 5A, and an axis which is orthogonal to the X- and Y-axes is defined as the Z-axis, as shown in FIG. 5B. In the following description, a direction horizontal to the X-axis direction will be referred to as the right side, and a direction opposite to the right side will be referred to as the left direction. Also, a direction horizontal to the Y-axis direction will be referred to as the back side, and a direction opposite will be referred to as the front side. A direction horizontal to the Z-axis direction will be referred to as the upper side, and a direction opposite to the upper side will be referred to as the lower side. Each side of the electronic device 1 is to be disposed parallel to the X-axis or Y-axis. That is, the body device 101 and the display device 102 each have two sides in a longitudinal direction which are parallel to the X-axis and two sides in a short-side direction which are parallel to the Y-axis. Note that line A-A is a straight line parallel to the Y-axis.

The body device 101 and the display device 102 are connected to each other in a foldable manner by the hinges 10 which connect the longitudinal sides of their respective devices 101 and 102 as described above.

As shown in FIG. 5A, the HDD 115 is arranged in a corner at the back on the right side of the body device 101 (the first housing 1A), and near one of the hinges 10 of the body device 101. As shown in FIG. 5A, the actuator 220 and the magnetic sensor 150 are arranged in the same line (A-A). Further, as shown in FIG. 5B, the HDD 115 is disposed such that the actuator 220 is positioned on the side of the hinge 10.

The magnetic sensor 150 is provided on the front side on the right of the display device 102 (the second housing 1B). In a state where the opening-closing-type electronic device 1 is opened, as shown in FIG. 5B, the magnetic sensor 150 and the actuator 220 are provided such that they are mutually symmetrical with respect to plane P passing through the rotation axis of the hinge 10.

FIG. 6A is a plan view showing the closed state of the opening-closing-type electronic device 1. FIG. 6B is a cross-sectional view taken along line B-B of FIG. 6A. Note that line B-B is a straight line parallel to the Y-axis. As shown in FIG. 6A, in the closed state, the actuator 220 and the magnetic sensor 150 are arranged to overlap one another as seen from the upper side. That is, as shown in FIG. 6B, in the closed state, the magnetic sensor 150 and the actuator 220 are arranged coaxially along the Z-axis direction.

In the present embodiment, when the display device 102 (the second housing 1B) of the opening-closing-type electronic device 1 is closed with respect to the body device 101 (the first housing 1A), the magnetic sensor 150 detects the magnetic field of the actuator 220 of the HDD 115. When the magnetic sensor 150 detects a magnetic flux density that is greater than or equal to a threshold of the actuator 220, the output portion 151 of the magnetic sensor 150 transmits a signal of detection level “Low” to the EC 140. When the signal of detection level “Low” is received, the EC 140 transmits a signal for turning off display of the display 161 or bringing the display 161 into a sleep state to the CPU 111. By the control of the EC 140, the display of the display 161 is turned off or the display 161 is brought into the sleep state. Note that the EC 140 may be operated to power the opening-closing-type electronic device 1 off.

Also, in the opening-closing-type electronic device 1 which is closed, when the display device 102 (the second housing 1B) and the body device 101 (the first housing 1A) are opened, the magnetic sensor 150 moves away from the actuator 220. When the magnetic sensor 150 is separated from the actuator 220 by a predetermined distance, the magnetic flux density detected by the magnetic sensor 150 is less than or equal to the threshold. When the magnetic flux density detected by the magnetic sensor 150 is less than or equal to the threshold, the output portion 151 of the magnetic sensor 150 transmits a signal of detection level “High” to the EC 140. When the signal of detection level “High” is received, the EC 140 transmits a signal for turning on display of the display 161 from the sleep state to the CPU 111. By the control of the EC 140 and the CPU 111, the display of the display 161 is turned on or brought into an activated state. Note that when the opening-closing-type electronic device 1 is powered off, the EC 140 may be operated to power the opening-closing-type electronic device 1 on.

According to the present embodiment, in a state where the opening-closing-type electronic device 1 is closed, the actuator 220 of the HDD 115 and the magnetic sensor 150 are arranged in line along the Z-axis direction. As the magnetic sensor 150 detects a magnetic flux density that is greater than or equal to the threshold of the actuator 220, the opening-closing-type electronic device 1 can switch the display of the display 161 or on/off of the power in accordance with the control of the EC 140. Since it is unnecessary to provide a magnet for controlling the display of the display 161 or on/off of the power by the opening and closing of the opening-closing-type electronic device 1, the number of components can be reduced. Consequently, the opening-closing-type electronic device 1 can be downsized. Also, because the HDD 115 is provided near the hinge 1C, even if the opening-closing-type electronic device 1 is moved greatly, an impact is hard to be transmitted to the HDD 115. That is, impact resistance of the HDD 115 in the opening-closing-type electronic device 1 of the present embodiment is improved.

A modification of the present embodiment will be described hereinafter with reference to the accompanying drawings. Since an opening-closing-type electronic device 1 of the modification has substantially the same structure as the opening-closing-type electronic device 1 of the first embodiment, structural elements identical to those of the opening-closing-type electronic device 1 in the first embodiment will be denoted by the same reference numbers as in the first embodiment, and detailed explanations of them will be omitted.

(Modification)

The modification of the present embodiment will be described. The opening-closing-type electronic device 1 of the modification is different from the opening-closing-type electronic device 1 of the first embodiment in the opening and closing structure.

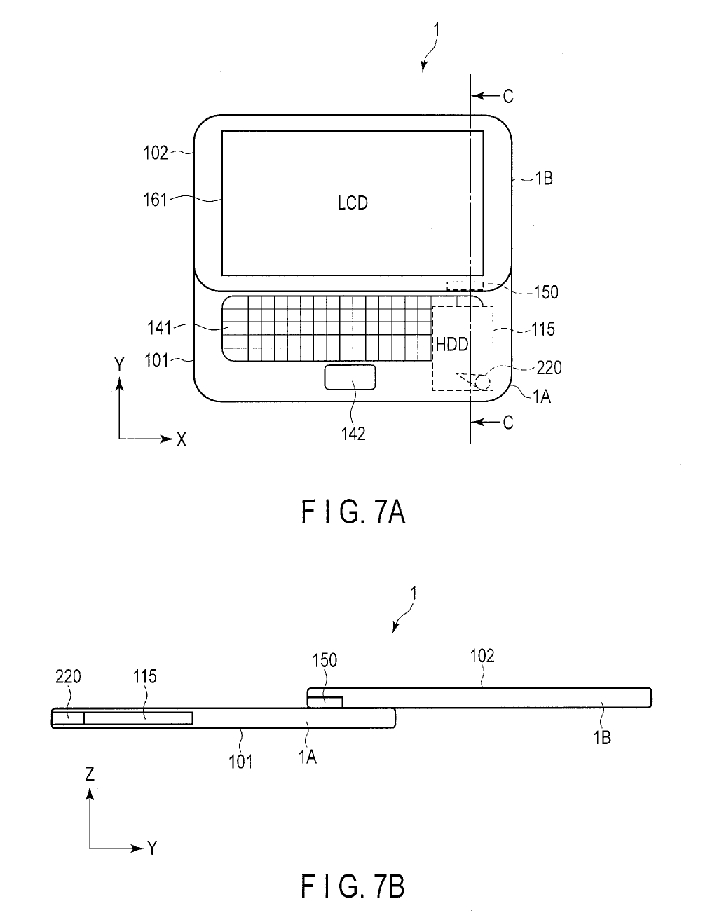

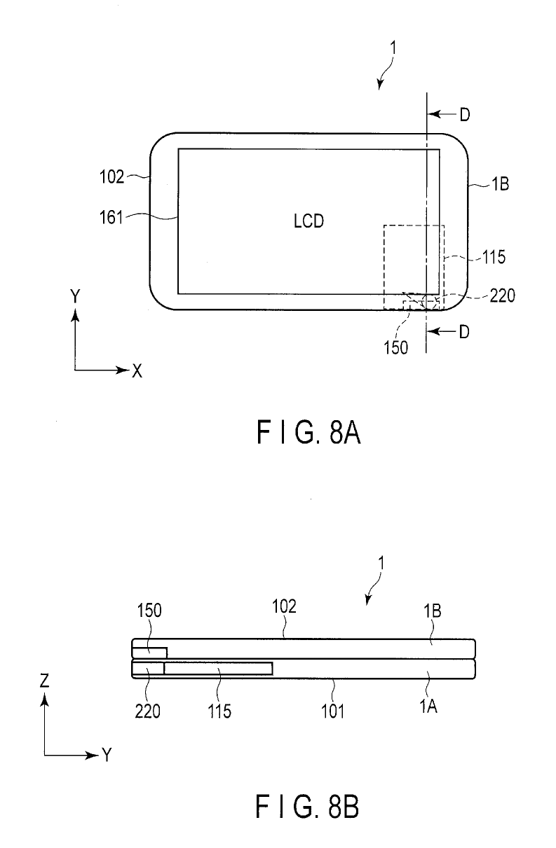

With reference to FIGS. 7A, 7B, 8A, and 8B, the opening-closing-type electronic device 1 of the modification will be described. FIG. 7A is a plan view showing an opened state of the opening-closing-type electronic device 1 of the modification. FIG. 7B is a cross-sectional view taken along line C-C of FIG. 7A. FIG. 8A is a plan view showing a closed state of the opening-closing-type electronic device 1 of the modification. FIG. 8B is a cross-sectional view taken along line D-D of FIG. 8A. Note that lines C-C and D-D are straight lines parallel to the Y-axis.

The opening-closing-type electronic device 1 of the modification comprises a sliding type opening and closing mechanism. As shown in FIGS. 7A and 7B, a body device 101 (a first housing 1A) is provided above a display device 102 (a second housing 1B) in a slidable way in the Y-axis direction.

In a state in which the opening-closing-type electronic device 1 is opened, an HDD 115 is arranged such that an actuator is provided in a corner on the front side on the right of the body device 101 (the first housing 1A), as shown in FIG. 7A. A magnetic sensor 150 is provided in a corner on the front side on the right of the display device 102 (the second housing 1B). As shown in FIG. 7A, the actuator 220 and the magnetic sensor 150 are arranged in the same line (C-C) along the Y-axis direction.

In a state in which the opening-closing-type electronic device 1 is closed, the HDD 115 and the actuator 220 are arranged in line along the Z-axis direction, as shown in FIGS. 8A and 8B.

In the present embodiment, when the form of the opening-closing-type electronic device 1 is changed from the opened state to the closed state by a sliding operation, the magnetic sensor 150 detects a magnetic flux density that is greater than or equal to a threshold. When the magnetic sensor 150 has detected a magnetic flux density that is greater than or equal to the threshold, by control of an EC 140, display of a display 161 is turned off or the display 161 is brought into a sleep state.

When the opening-closing-type electronic device 1 is made to slide from the closed state to the opened state, the magnetic sensor 150 detects a magnetic flux density that is less than or equal to the threshold. When the magnetic sensor 150 has detected a magnetic flux density that is less than or equal to the threshold, by control of the EC 140, the display of the display 161 is turned on or brought into an activated state.

In the present embodiment, the opening-closing-type electronic device 1 comprises the sliding type opening and closing mechanism. Also, in the state where the opening-closing-type electronic device 1 is closed, the actuator 220 of the HDD 115 and the magnetic sensor 150 are arranged in line along the Z-axis direction. As the magnetic sensor 150 detects a magnetic flux density that is greater than or equal to the threshold of the actuator 220, the opening-closing-type electronic device 1 can switch the display of the display 161 or on/off of the power. Therefore, since it is unnecessary to provide a magnet for controlling the display of the display 161 or on/off of the power by the opening and closing of the opening-closing-type electronic device 1, the number of components can be reduced. Consequently, the opening-closing-type electronic device 1 with the sliding type opening and closing mechanism can also be downsized.

Note that the opening-closing-type electronic device 1 does not have to be slid to open and close it, but may be, for example, rotated. For example, the display device 102 may be rotatably connected to the body device 101 at a corner portion on an upper right side.

Next, an opening-closing-type electronic device of another embodiment will be described. In another embodiment, the same reference numbers are assigned to portions which are the same as in the aforementioned first embodiment, and detailed explanations of them will be omitted.

### Second Embodiment

A second embodiment will be hereinafter described. An opening-closing-type electronic device 1 of the second embodiment is constituted of a body device 101 and an input device (input unit) 103.

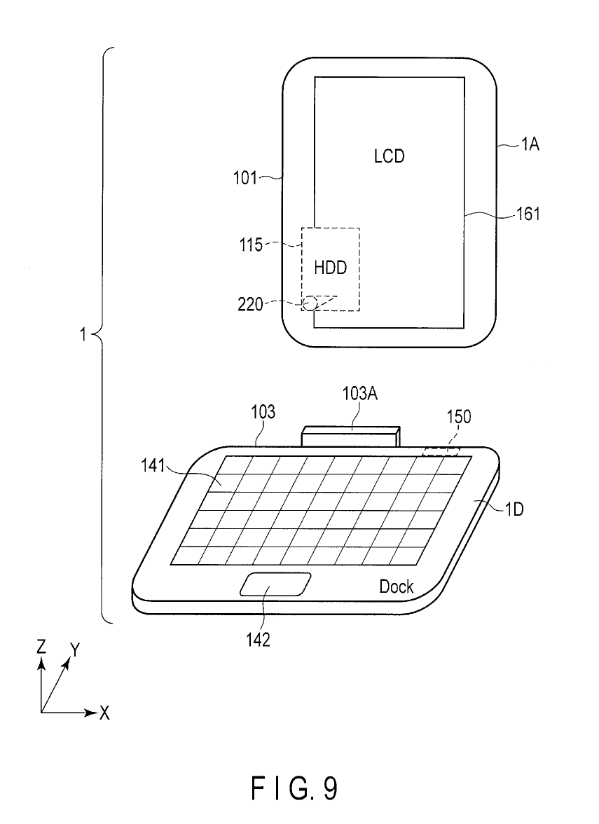

FIG. 9 is a schematic view of the opening-closing-type electronic device 1 of the present embodiment. The opening-closing-type electronic device 1 of the present embodiment comprises a first housing 1A and a third housing 1D. The first housing 1A and the third housing 1D are connected detachably and in an openable and closable way. The first housing 1A includes the body device 101, and the third housing 1D includes the input device 103.

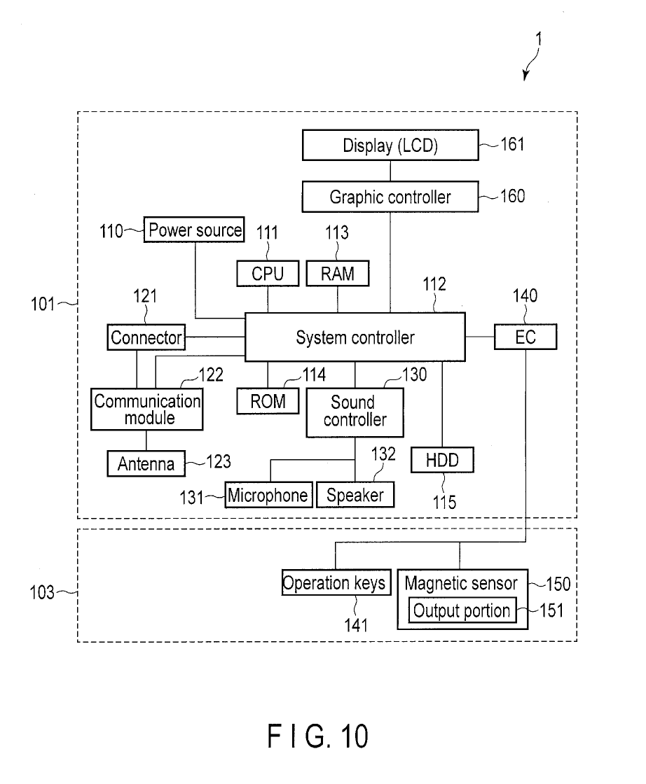

FIG. 10 is a block diagram of the opening-closing-type electronic device 1 of the present embodiment. As shown in FIG. 10, the body device 101 has substantially the same structure as that of the first embodiment, and further comprises a graphic controller 160 and a display 161 in the first housing 1A.

The input device 103 comprises a connection portion 103A, operation keys 141, and a magnetic sensor 150 in the third housing 1D. The input device 103 is a dock-type keyboard, for example. The body device 101 is removably connected to the connection portion 103A of the input device 103. The connection portion 103A is provided such that it can be rotated and moved toward the input device 103. When the body device 101 is connected to the connection portion 103A, the body device 101 and the input device 103 are electrically connected to each other as well. It should be noted that the body device 101 and the input device 103 are configured such that they can transmit and receive information via a communication apparatus.

(Structure of Opening-Closing-Type Electronic Device)

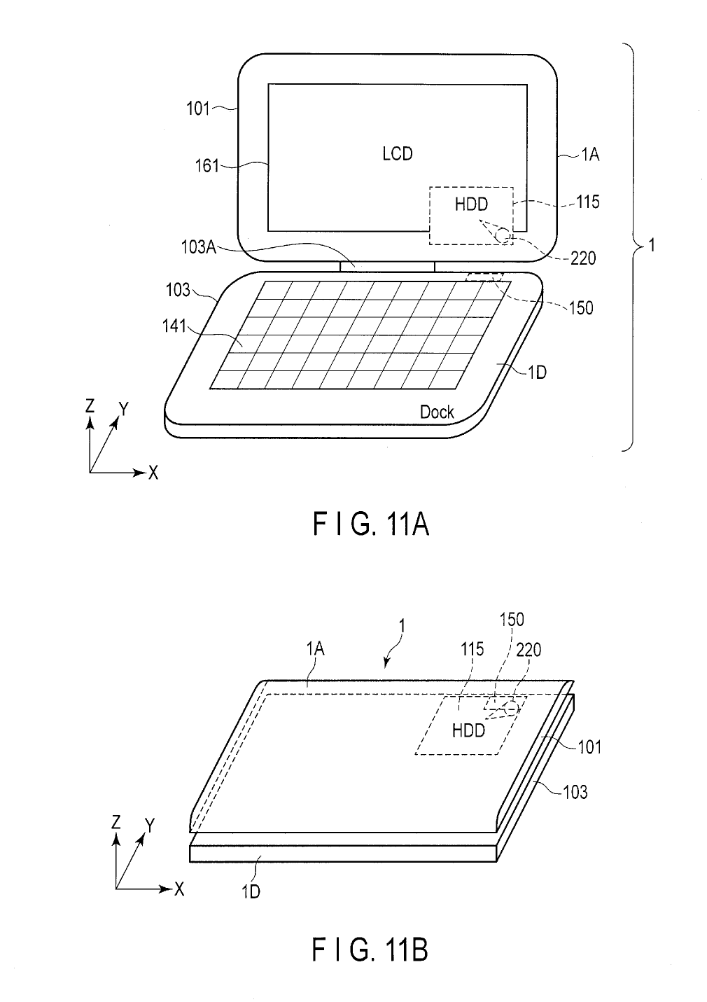

Next, a structure of the opening-closing-type electronic device 1, and arrangement of an HDD 115 and a magnetic sensor 150, in particular, will be described with reference to FIGS. 11A and 11B. In the present embodiment, the magnetic sensor 150 detects a magnetic field of an actuator 220, and an opened or closed state of the opening-closing-type electronic device 1 is controlled by an EC 140. In a state where the opening-closing-type electronic device 1 is closed, the HDD 115 and the magnetic sensor 150 are disposed to face each other. That is, the HDD 115 and the magnetic sensor 150 are arranged so that they face each other in line when the opening-closing-type electronic device 1 is closed. For example, the magnetic sensor 150 is provided at a portion which faces a VCM 222 of the actuator 220.

FIG. 11A is a perspective view showing an opened state of the opening-closing-type electronic device 1. FIG. 11B is a perspective view showing a closed state of the opening-closing-type electronic device 1. As shown in FIG. 11A, the HDD 115 is arranged in a corner on the front side on the right of the body device 101 (the first housing 1A). The magnetic sensor 150 is provided at the back on the right of the input device 103 (the third housing 1D). As shown in FIG. 11B, in a state where the opening-closing-type electronic device 1 is closed, the magnetic sensor 150 and the actuator 220 are arranged in line along the Z-axis direction.

In the present embodiment, the body device 101 of the opening-closing-type electronic device 1 is connected to the input device 103. When the body device 101 is closed with respect to the input device 103, the magnetic sensor 150 detects a magnetic field of the actuator 220 of the HDD 115. When the magnetic sensor 150 detects a magnetic flux density that is greater than or equal to a threshold of the actuator 220, an output portion 151 of the magnetic sensor 150 transmits a signal of detection level “Low” to the EC 140. When the signal of detection level “Low” is received, the EC 140 transmits a signal for turning off display of the display 161 or bringing the display 161 into a sleep state to a CPU 111. By the control of the EC 140, the display of the display 161 is turned off or the display 161 is brought into the sleep state. Note that the EC 140 may be operated to power the opening-closing-type electronic device 1 off.

Also, in the opening-closing-type electronic device 1 which is closed, when the body device 101 and the input device 103 are opened, the magnetic sensor 150 moves away from the actuator 220. When the magnetic sensor 150 is separated from the actuator 220 by a predetermined distance, the magnetic flux density detected by the magnetic sensor 150 is less than or equal to the threshold. When the magnetic flux density detected by the magnetic sensor 150 is less than or equal to the threshold, the output portion 151 of the magnetic sensor 150 transmits a signal of detection level “High” to the EC 140. When the signal of detection level “High” is received, the EC 140 transmits a signal for turning on display of the display 161 from the sleep state to the CPU 111. By the control of the EC 140 and the CPU 111, the display of the display 161 is turned on or brought into an activated state. Note that when the opening-closing-type electronic device 1 is powered off, the EC 140 may be operated to power the opening-closing-type electronic device 1 on.

According to the present embodiment, the body device 101 is connected to the input device 103. In a state where the body device 101 is closed with respect to the input device 103, the actuator 220 of the HDD 115 and the magnetic sensor 150 are arranged in line along the Z-axis direction. As the magnetic sensor 150 detects a magnetic flux density that is greater than or equal to the threshold of the actuator 220, the opening-closing-type electronic device 1 can switch the display of the display 161 or on/off of the power in accordance with the control of the EC 140. Even if the body device 101 is a mobile terminal, by connecting it with the input device 103, on/off of display of the display 161 can be switched.

According to the above embodiment, in the state where the opening-closing-type electronic device 1 is closed, the actuator 220 of the HDD 115 and the magnetic sensor 150 are arranged in line along the Z-axis direction. As the magnetic sensor 150 detects a magnetic flux density that is greater than or equal to the threshold of the actuator 220, the opening-closing-type electronic device 1 can switch the display of the display 161 or on/off of the power in accordance with the control of the EC 140. Since it is unnecessary to provide a magnet for controlling the display of the display 161 or on/off of the power by the opening and closing of the opening-closing-type electronic device 1, the number of components can be reduced. Consequently, the opening-closing-type electronic device 1 can be downsized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An opening-closing-type electronic device comprising:
a magnetic recording medium comprising a drive member comprising a magnet, and a drive assembly driven by the drive member;
a magnetic sensor to detect a magnetic field of the magnetic recording medium and to output a signal when a magnetic flux density of the magnetic field reaches a threshold; and
an opening and closing mechanism to be opened and closed, wherein a part of the magnetic recording medium and the magnetic sensor face each other when the mechanism is closed.

2. The device of claim 1, wherein the part of the magnetic recording medium comprises a part of the drive assembly.

3. The device of claim 1, wherein the part of the magnetic recording medium comprises the drive member.

4. The device of claim 2, further comprising a control unit to control power supply in accordance with the signal output from the magnetic sensor, in receipt of the signal output from the magnetic sensor when the opening and closing mechanism is opened or closed.

5. The device of claim 3, further comprising a control unit configured to control power supply in accordance with the signal output from the magnetic sensor, in receipt of the signal output from the magnetic sensor when the opening and closing mechanism is opened or closed.

6. The device of claim 4, wherein:
the opening and closing mechanism comprises a display unit configured to display an image, and a body unit connected to the display unit electrically and in an openable and closable way, the body unit comprising an input operation portion configured to receive an operation instruction, a controller configured to control display of the image, and a connection portion configured to connect the display unit and the controller, wherein;
the display unit comprises the magnetic sensor; and
the body unit comprises the magnetic recording medium.

7. The device of claim 5, wherein:
the opening and closing mechanism comprises a display unit configured to display an image, and a body unit connected to the display unit electrically and in an openable and closable way, the body unit comprising an input operation portion configured to receive an operation instruction, a controller configured to control display of the image, and a connection portion configured to connect the display unit and the controller, wherein;
the display unit comprises the magnetic sensor; and
the body unit comprises the magnetic recording medium.

8. The device of claim 4, wherein:
the opening and closing mechanism comprises a body unit comprising a controller configured to control display of an image, the body unit configured to display the image in accordance with control of the controller, and an input unit connected to the body electrically and in an openable and closable way, the input unit comprising an input operation portion configured to receive an operation instruction, wherein;
the body unit comprises the magnetic recording medium; and
the input unit comprises the magnetic sensor.

9. The device of claim 5, wherein:
the opening and closing mechanism comprises a display unit comprising a controller configured to control display of an image, the display unit configured to display the image in accordance with control of the controller, and an input unit connected to the display unit electrically and in an openable and closable way, the input unit comprising an input operation portion configured to receive an operation instruction;
the body unit comprises the magnetic recording medium; and
the input unit comprises the magnetic sensor.

10. The device of claim 6, wherein the magnetic sensor is provided on a side of the connection portion connected with the body unit, and the magnetic recording medium is provided on a side of the connection portion connected with the display unit.

11. The device of claim 7, wherein the magnetic sensor is provided on a side of the connection portion connected with the body unit, and the magnetic recording medium is provided on a side of the connection portion connected with the display unit.
